(19) United States
(12) Patent Application Publication
(10) Pub. No.: US 2015/0098539 A1
(43) Pub. Date: Apr. 9, 2015

(54) Method for synchronizing the recording of data in pipeline networks

(71) Applicant: Seba-Dynatronic Mess-und Ortungstechnik GmbH, Baunach (DE)

(72) Inventors: Max Iann, Baunach (DE); Harald Schuberth, Breitenguessbach (DE); Michael Sarvan, Bamberg (DE)

(21) Appl. No.: 14/253,567

(22) Filed: Apr. 15, 2014

(30) Foreign Application Priority Data
Oct. 9, 2013 (DE) 10 2013 016 744.2
Mar. 12, 2014 (DE) 10 2014 003 554.9

(51) Int. Cl. H04W 56/00; G01M 3/24; G08C 17/02

(52) U.S. Cl. CPC H04W 56/001; G08C 17/02; G01M 3/243
USPC 375/356

(57) ABSTRACT

A method and device for synchronizing the recording of data in pipeline networks, in which at least two sensor units arranged spaced apart are disposed for detecting a leak, each sensor unit including at least one sensor for registering an analog signal, at least one GPS receiver and at least one communication module which communicates by radio with at least one data logger, characterized in that the synchronization for the purpose of recording data is started via a GPS trigger pulse from at least one GPS satellite.

The present invention relates to a method and a device for synchronizing the recording of data in pipeline networks.

Cited as prior art is DE 195 28 287 C5. This document relates to a method for detecting a leak in a drinking water supply network and a system for carrying out the method.

From this document it is already known that a plurality of at least three sonic sensors are positioned in a configuration which allows for correlated processing of the output signals of any one sensor with the output signals of at least two additional sensors disposed on one side of the former.

In this case, it is presupposed that multiple sensors are distributed in a water supply network and each sensor is connected to a communication module which is in radio-based communication with a control center and a data logger located there.

When called up with the aid of a radio-controlled call signal from the control center, the communication modules associated with the individual sensors then send their digital data generated at the measuring location to the control center.

This document provides no information on the type of synchronization of the signals of the individual sensors. A synchronization of signals of these sensors is simply presupposed. How this takes place and by which measures is not apparent to the person skilled in the art.

The disadvantage of the radio-controlled call-up of the digital data from each sensor is that—if the call-up signal is disrupted in any way—the prompted sensor and the associated communication module send no data. The call pulse is lacking and, as a result, significant errors occur when evaluating the data.

Nor is it possible to complete an evaluation because it is precisely the signals of the prompted sensors that are missing and cannot be sent later.

Japanese publication JP 3829966 B2 deals with the problem of synchronizing signals from sensors, each of which are connected to a communication module.

For this purpose, the aforementioned document uses a satellite GPS signal and it entails each sensor being assigned a radio receiver module so that the satellite signal is transmitted directly from the satellite to the communication module via the radio interface. Thus, each communication module of the sensor receives a GPS satellite signal and can be synchronized with high precision as a result.

The disadvantage of this arrangement, however, is that the synchronization signal of the GPS satellite is superimposed on the audio signal of the sensor. There is a risk, therefore, that the audio signal is partially or wholly overwritten the moment the satellite signal is superimposed on the audio signal, which can result in significant error interferences.

Therefore, starting from JP 3829966 B2, the object of the invention is to further develop a method for synchronizing the recording of data in pipeline networks in such a way that a substantially more reliable synchronization results without disruption to data traffic.

Acoustic methods amongst others are employed in the state of the art for monitoring pipeline networks and for locating leakages. In these methods, the noise signal arising at a leakage in a pipeline under pressure is recorded via acoustic sensors and further processed.

The signal is analyzed either at only one measuring point or at several measuring points in the network. The measurement results are compared with one another in order to accurately locate the leakage.

Correlation is one option for pinpointing the location of the leakage.

In this method a noise signal is recorded at the measuring point via a structure-borne microphone or hydrophone and is relayed with the aid of digital electronics. The signal from two or more measuring points is then evaluated using correlation function. With the correlation, it is possible to calculate the similarity as well as the time delay between two signals Based on the time delay, the length of the line between two measuring points and the speed of propagation of the correlated signal it is possible to calculate the distance between the leak and the two measuring points.

Crucial for correlation is the synchronization when recording the measuring signals. An error in the synchronization is directly included as a measurement error with respect to the distance to the leakage. The accuracy required lies within the range of a few milliseconds.

Currently, the synchronization is achieved by the following measures:
field correlator: the noise signals are transmitted in two or more channels simultaneously by cable or radio to the main unit (correlator). This results in an automatic synchronized scanning in the correlator.
correlating radio loggers: The radio network via which data is communicated between the loggers is also used for synchronization during recording. This means that within the network a real-time radio communication must be possible.

Since correlation may also be carried out over relatively long distances, a direct radio communication between the measuring points is sometimes not possible. This then eliminates the possibility of synchronization with the required accuracy.

For example, the transmission of data is implemented via GSM/GPRS networks. Such networks allow the transmission of audio data and other information, but are not suited to synchronizing the recording of data.

To solve the stated problem, the invention is characterized by the technical teaching of claim 1.

The essential feature of the invention is that the trigger signal of the GPS satellite is used merely as a start signal for the recording of data of an analog signal of the sensor, this GPS trigger signal being the start signal for the A/D converter which executes the evaluation of the analog signal for a precisely defined period of time and converts the analog signal into a digital data word.

This provides the significant advantage that the GPS trigger signal is now used only for the ND converter and is neither superimposed on the analog signal, which could result in a disruption of the analog signal, nor does it occur as the result of a highly precise clock or the like, as is specified in DE 195 28 287 C5.

The start of the measuring period or the evaluation of the A/D converter is therefore a precisely defined synchronization variable and all of the sensors with attached communication module execute this recording simultaneously. This means that, though the analog signal is constantly applied at the respective A/D converter of each sensor, the A/D converter—controlled by the signal that has been generated by the GPS satellite—begins and ends the evaluation of the analog signal in a precisely defined period of time.

Thus, the GPS trigger signal may be used as a start signal as well as an interrupt signal for the A/D converter.

In this case, it is not essential to the solution for the GPS signal to also determine the end of the conversion process in the A/D converter. The A/D converter after practically just a one-time start, may be in constant operation and execute the conversion, whereby a specific data word is then tapped at the output of the A/D converter which is then written into a memory connected downstream.

In the present invention the GPS may be preferably used for the following two variants.

a) The A/D converter converts the input signal permanently into a digital data stream. The GPS signal is used only to determine the point in time from which the data are written in the downstream memory.

b) The A/D converter converts the input signal permanently into a digital data stream, which is rotatingly written in a downstream memory. In this variant, the GPS signal marks only the beginning of a data block within the memory, which is used for the subsequent data processing.

Rotating writing of the memory is understood in the application to mean that when the memory is full, the memory pointer returns to start and overwrites the oldest data with current data. This pointer therefore “rotates” permanently over the entire memory area. This ensures that the most current data is always available.

Forming part of the communication module, therefore, is a data memory into which the data words generated by the ND converter are periodically written in. The communication module then transmits the stored data independently—preferably radio-supported—to the control center with the data logger.

This may involve various radio transmission methods.

In a first embodiment of the invention, it is provided that the radio-supported transmission takes place via the GSM network. This has the advantage that other additional digital information may also be transmitted via such a network, for example, the sensor ID, specific parameters and the like.

In a second embodiment of the invention, it may be provided that a separate radio network is used, which is divided into different channels, each sensor being assigned a corresponding transmission channel.

This radio transmission may take place in various transmission modes, for example, using the multiplex principle, the time slot method and the like.

Accordingly, the advantage of the method according to the invention is that without being prompted, the digital data of each sensor—communication module is dispatched to the control center, thereby ruling out the possibility that a signal is disrupted. If a particular signal of a communication module is not received by the control center, the evaluation is not performed.

The respective sensor with the associated communication module then resends at the next possible point in time, whereby such points in time may be arbitrarily selected. Points in time of, for example, 1 day, several hours or the like may be provided.

In the GPS network available worldwide, a very precise time signal, the so-called “second pulse”, is transmitted via satellite. The second pulse of a GPS receiver has a jitter of only a few nanoseconds, thus, GPS may be used as a time standard for measuring frequency and time. Some GPS receivers supply a corrective signal and are particularly suited to such tasks. If such a GPS module is now used at measuring points that are not in direct radio contact with one another, it is possible via such a module for the synchronization required for recording data to occur. The actual transmission of measurement data then continues to take place via radio networks, GSM, GPRS, etc.

Accordingly, the core of the invention lies in a method proposed for locating leakages in a pipeline network, in which the synchronization for purpose of recording data is achieved via the so-called second pulse of a GPS satellite network.

The inventive subject matter of the present invention derives not only from the subject matter of the individual patent claims, but also from the individual claims when combined with each other.

All specifications and features disclosed in the application papers, including the abstract, in particular the spatial configuration shown in the drawings, are claimed as essential to the invention insofar as they are novel over the state of the art, individually or in combination.

The invention is described in greater detail below with reference to drawings showing just one mode of execution. In this context, additional features essential to the invention and advantages are apparent from the drawings and their description, in which:

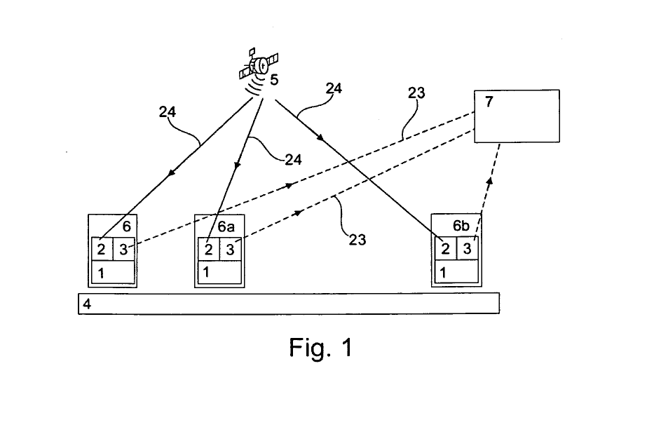

FIG. 1 shows a schematic representation of a communication network of sensors which are synchronized via a GPS satellite

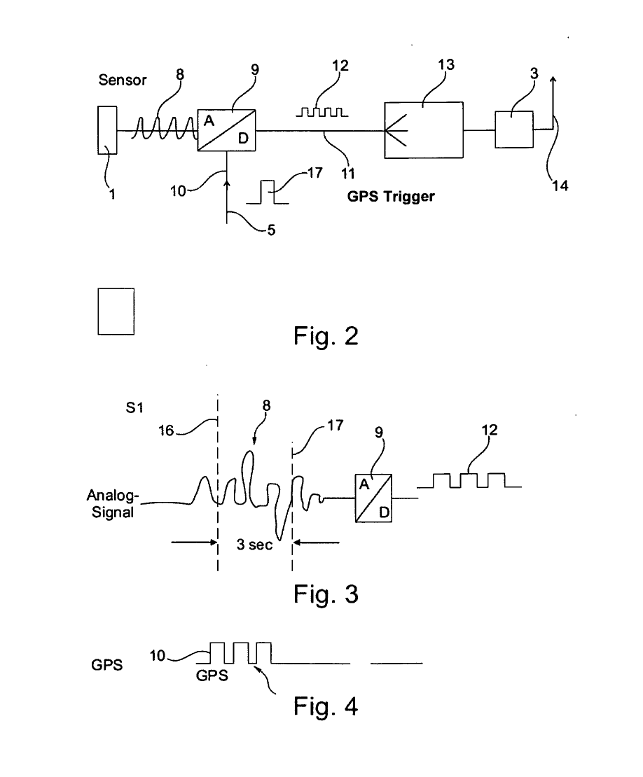

FIG. 2 shows a schematic block diagram of a sensor and communication module

FIG. 3 shows schematically the signal sequence at a sensor with conversion to a digital data word

FIG. 4 shows the associated second trigger pulse of the GPS satellite

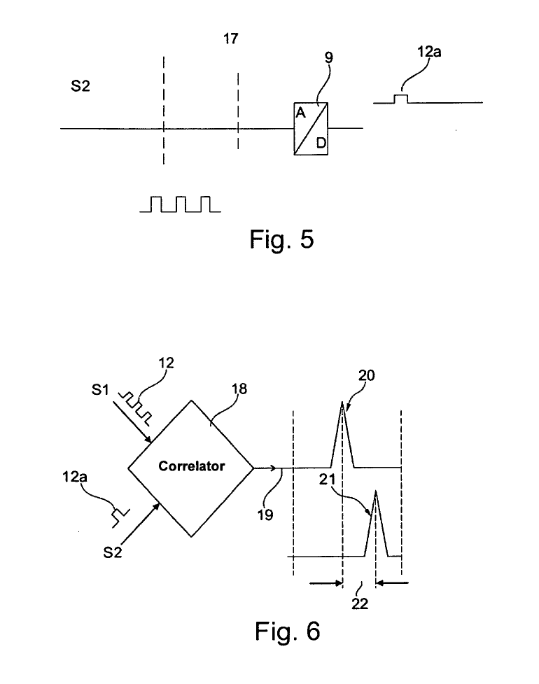

FIG. 5 shows a signal curve of a sensor which has received no noise-induced analog data

FIG. 6 shows schematically the representation of a correlator with specified output pulse.

FIG. 1 schematically shows that a number of sensor units 6, 6a, 6b are arranged along a pipeline network 4 which may be widely branched, each sensor unit 6, 6a, 6b including at least one analog sensor 1, at least one GPS receiver 2 and at least one communication module 3. The communication module 3 is capable of transmitting by radio, in each case over radio transmission path 23, the generated digital data to a data logger 7, which is preferably designed as a control center.

From the GPS satellite 5 or from a GPS satellite network 5, a so-called second pulse is transmitted in a manner known per se, which is sent simultaneously and synchronously to each of the sensor units 6, 6a, 6b over the radio transmission path 24. This trigger pulse 10 is received and evaluated by each GPS receiver 2 in the sensor unit 6, 6a, 6b.

FIG. 2 schematically shows a block diagram of a sensor unit 6, in which it is apparent that an analog sensor 1 generates a leak noise-induced analog signal 8 which is fed to an A/D converter 9. Important here is that the trigger pulse 10 (=second pulse) generated by the GPS satellite 5 as GPS trigger signal 17 is now used as a start signal 16 for beginning the evaluation of the analog signal 8 according to FIG. 3.

Accordingly, the A/D converter 9 carries out the A/D conversion according to FIG. 2 and generates a digital data word 12 which is written into a memory 13. The communication module 3 is arranged at the output of the memory 13 with the antenna 14, which executes a transmission on the radio transmission path 13 in the direction of the data logger 7.

In another preferred embodiment, the A/D converter 9 permanently converts the analog signal 8 into a digital data stream. The GPS signal 16 is used only to determine the point in time as of when the data 12 are written in the downstream memory 13.

In another embodiment, the A/D converter 9 permanently converts the analog signal 8 (=input signal) into a digital data stream 12 which is rotatingly written in a downstream memory 13. The GPS signal 16, 17 is used only to mark the beginning of a data block within the memory 13, which is used for the subsequent data processing.

Accordingly, the GPS trigger signal 17 is used according to FIG. 3 as a start signal 16 for the leak noise-induced analog signal 8, which is evaluated for a specific period of time.

Instead of the evaluation over a specific period of time, a permanent evaluation may also take place. The evaluation takes place in the A/D converter 9, based upon which the latter generates the digital data word 12.

FIG. 4 shows that the trigger pulse 10 is derived from the GPS trigger signal and that in this case, for example, a measuring period of, for example, 3 seconds is provided.

FIG. 5 shows that the start signal 16 is also fed to the other sensor S2 which, however has received no leak noise-induced analog signal during the measuring period, such that the downstream A/D converter generates a data word 12a which differs from the data word 12.

According to FIG. 6, the two digital data words 12, 12a are fed into a correlator, at the output 19 of which the correlation function 20 appears.

If the correlation function 20 is disposed for example in the middle between two measuring points, as shown in FIG. 6, this indicates that the leak noise originated in the middle between sensors 6, 6a.

If on the other hand the correlation function 21 is displaced by a delay 22, for example, to the left or right, it may be inferred from this that the leak noise originated in closer proximity to the one sensor unit 6 or the other sensor unit 6a.

The advantage of the method according to the invention is to synchronize the recordings of differing sensor units 6, 6a, 6b which are not in radio contact with one another.

DE 195 28 287 C5 required namely that the individual sensors communicate with one another. This is unnecessary with the present invention. The present invention has the advantage that the GPS trigger signal is used only as a trigger pulse for initiating the AD conversion, which rules out the possibility that the analog signal itself could be disrupted by the trigger signal. In the present invention a continuous, periodic synchronization is generated—caused by the second signal of the GPS trigger signal 17—which is specifically not the case in the subject matter of DE 195 28 287 C5, because in the latter case a synchronization takes place via quartz-controlled clocks or the like, which are known to lose their accuracy and require continual readjustment.

A GPS signal is available at any location and the advantage is that with the calculation of the GPS coordinates of each sensor unit, it is also possible to detect the distance and the location of each sensor unit in the pipeline network and to also transmit these to the data logger. The distance of a leak in relation to the sensors is determined based on the distance information and the delay time which is given based on the correlation function 20, 21 with regard to delay 22.

### DRAWING LEGENDS

1. sensor
2. GPS receiver
3. communication module
4. pipeline network
5. GPS satellite
6. sensor unit 6a, b
7. data logger (control center)
8. analog signal
9. A/D converter
10. trigger pulse
11. output
12. data value 12a
13. memory
14. antenna
15.
16. start signal
17. GPS trigger signal
18. correlator
19. output
20. correlation function
21. correlation function
22. delay
23 radio transmission path
24 radio transmission path

1. A method for synchronizing the recording of data in pipeline networks (4) in which at least two sensor units (6, 6a, 6b) arranged spaced apart are disposed for detecting a leak, each sensor unit (6, 6a, 6b) including at least one sensor (1) for registering an analog signal (8), at least one GPS receiver (2) and at least one communication module (3) which communicates by radio with at least one data logger (7), characterized in that the synchronization for the purpose of recording data is started via a GPS trigger signal (17) from at least one GPS satellite (5).

2. The method according to claim 1, characterized in that the GPS trigger signal (17) is used as a start signal (16) for at least one A/D converter (9), which carries out digitalization of the analog signal (8).

3. The method according to claim 2, characterized in that the GPS trigger signal (17) addresses simultaneously all sensor units (6, 6a, 6b) with the respective A/D converters (9).

4. The method according to claim 3, characterized in that the A/D converter (9) starts and ends the evaluation again for a defined period of time.

5. The method according to claim 4, characterized in that the GPS trigger signal (17) is used as an interrupt signal for the A/D converter 9.

6. The method according to claim 1, characterized in that the communication module (3) executes radio-based transmission via a GSM network or via a separate radio network.

7. The method according to claim 1, characterized in that distance and position of the sensor unit (6, 6a, 6b) is detectable due to the GPS trigger signal (17) and is transmitted to the data logger (7).

8. The method according to claim 7, characterized in that a distance of a leak to the sensors (6, 6a, 6b) is determined based on a correlation function (20, 21) and a potential delay (22).

9. The method according to claim 1, characterized in that the A/D converter (9) converts the analog signal (8) permanently into a digital data value (12), and that the GPS signal (16) determines a point in time as of when the data (12) are written in the downstream memory (13).

10. The method according to claim 1, characterized in that the A/D converter (9) converts the analog signal (8) permanently into a digital data stream (12), which is rotatingly written into a downstream memory (13), and that the GPS signal (16) marks a beginning of a data block within the memory (13).

11. A device for synchronizing the recording of data in pipeline networks (4), in which at least two sensor units (6, 6a, 6b) arranged spaced apart are disposed for detecting a leak, each sensor unit (6, 6a, 6b) including at least one sensor (1), at least one GPS receiver (2) and at least one communication module (3) which communicates by radio with at least one data logger (7), characterized in that each sensor unit (6, 6a, 6b) includes a GPS receiver (2) which receives a GPS trigger signal (17) which starts an A/D converter (9).
